(19) United States
(12) Patent Application Publication
(10) Pub. No.: US 2023/0262148 A1
(43) Pub. Date: Aug. 17, 2023

(54) COMMUNICATION TRANSLATION MODULE AND METHOD

(71) Applicant: Raytheon Company, Waltham, MA (US)

(72) Inventors: Alan G. Stuessy, McKinney, TX (US); Kendall Saer Ford, Sherman, TX (US)

(21) Appl. No.: 17/672,340

(22) Filed: Feb. 15, 2022

(51) Int. Cl. H04L 69/08; H04L 69/18

(52) U.S. Cl. CPC H04L 69/08; H04L 69/18

(57) ABSTRACT

An electronic communication translation module (CTM) for use with a system having a plurality of system components and at least one communication bus is provided. The communication bus is configured to transfer electronic communications in a standardized bus format. The CTM includes a protocol storage submodule and a processor. The protocol storage submodule stores a plurality of predetermined system component protocols (PSCPs), each associated with a respective system component. The processor is in communication with the protocol storage submodule and a memory storing instructions, which instructions when executed cause the processor to: a) identify a respective system component; and b) translate at least a portion of a respective system component electronic communication protocol into a standardized bus format transferable on the at least one communication bus using the selected PSCP.

### BACKGROUND OF THE INVENTION

### 1. Technical Field

The present disclosure relates to electronic data communications in general, and to devices and methods for translating electronic data communications in particular.

### 2. Background Information

Electronic communications between electronic subsystems and components within a system have always been challenged by differences in communication standards and protocols. Communications within a system have often been accomplished using proprietary or custom interfaces between the various electronic subsystems and components. In many instances, these proprietary or custom interfaces were configured for a specific device or subsystem and were very often “fixed in time”, meaning the interface was based on then existing software platforms or standards. When it later became desirable to modify or replace a subsystem, sensor, or the like, the existing protocol was no longer viable and it was necessary to create a new specific interface to accomplish the necessary communications. This problem and others led to initiatives like the Modular Open Systems Approach (“MOSA”) by the U.S. Government that required Department Acquisition Programs (e.g., acquisition programs for aircraft technology, ship technology, weapon management technology, electronic warfare technology, and the like) to utilize an “open architecture” that utilizes modular design practices that facilitate component/subsystem addition, modification, updating, replacement, and removal.

What is needed is a communications package/methodology that facilitates electronic communications within a system (e.g., an open architecture system) and makes attainable the goal of “plug and play” modular components within a system.

### SUMMARY

According to an aspect of the present disclosure, an electronic communication translation module for use with a system having at least one communication bus is provided. The communication bus is configured to transfer electronic communications in a standardized bus format. The system has a plurality of system components in electronic communication with the communication bus. Each system component is configured to produce at least one electronic communication protocol. The electronic communication translation module includes a protocol storage submodule and a processor. The protocol storage submodule is configured to store a plurality of predetermined system component protocols (PSCPs), and each PSCP is associated with the at least one electronic communication protocol of a respective system component. The processor is in communication with the protocol storage submodule storing instructions, which instructions when executed cause the processor to: a) identify a respective system component using at least a portion of the respective at least one electronic communication protocol of the respective system component and a selected PSCP; and b) translate at least a portion of the respective at least one system component electronic communication protocol into a standardized bus format transferable on the at least one communication bus using the selected PSCP.

In any of the aspects or embodiments described above and herein, the instructions when executed may cause the processor to translate one or more physical protocol elements, or one or more logical protocol elements, or both, associated with at least one system component electronic communication protocol into the standardized bus format using the selected PSCP.

In any of the aspects or embodiments described above and herein, the electronic communication translation module may be configured for bidirectional electronic communication translation.

In any of the aspects or embodiments described above and herein, the electronic communication translation module may be configured to receive electronic communications in the standardized bus format and the instructions when executed may cause the processor to translate the received electronic communications in the standardized bus format using at least one PSCP.

In any of the aspects or embodiments described above and herein, the electronic communication translation module may be configured to identify a plurality of system components, wherein each system component is different from each of the other system components.

According to another aspect of the present disclosure, a method of establishing electronic communications between a plurality of system components within a system is provided. The system has at least one communication bus in communication with the plurality of system components. The communication bus is configured to transfer electronic communications in a standardized bus format. The method includes: a) using a first communication translation module (CTM) to receive at least one electronic communication protocol from a first system component of the plurality of system components, the first CTM including a first protocol storage submodule configured to store a plurality of predetermined system component protocols (PSCPs); b) using the first CTM and a selected PSCP to identify the first system component using at least a portion of the at least one electronic communication protocol of the first system component received by the first CTM; c) using the first CTM and the selected PSCP from the first protocol storage submodule to translate the at least one electronic communication protocol of the first system component into an outgoing packet in standardized bus format transferable on the at least one communication bus; and d) transferring the outgoing packet on the at least one communication bus to at least another of the plurality of system components.

In any of the aspects or embodiments described above and herein, the at least another of the plurality of system components is a second system component, and the method may include: a) using a second CTM in communication with the second system component to receive the outgoing packet, the second CTM including a second protocol storage submodule configured to store a plurality of PSCPs; and b) using the second CTM and a PSCP from the second protocol storage submodule to translate the outgoing packet from the standardized bus format to at least a portion of an electronic communication protocol of the second system component.

In any of the aspects or embodiments described above and herein, the first CTM and the second CTM may each be configured for bidirectional electronic communications.

In any of the aspects or embodiments described above and herein, the translation of the at least one electronic communication protocol of the first system component may include translating one or more physical protocol elements, or one or more logical protocol elements, or both, associated with at least one system component electronic communication protocol into the standardized bus format using the selected PSCP from the first protocol storage submodule.

In any of the aspects or embodiments described above and herein, the first system component may be new to the system.

In any of the aspects or embodiments described above and herein, the method may include: a) replacing the first system component with a second system component; b) using the first CTM to receive at least one electronic communication protocol from the second system component of the plurality of system components; c) using the first CTM and a second selected PSCP to identify the second system component using at least a portion of the at least one electronic communication protocol of the second system component received by the first CTM; d) using the first CTM and the second selected PSCP from the first protocol storage submodule to translate the at least one electronic communication protocol of the second system component into an outgoing packet in the standardized bus format associated with the second system component; and e) transferring the outgoing packet associated with the second system component on the at least one communication bus to at least another of the plurality of system components.

In any of the aspects or embodiments described above and herein, the first CTM may include a plurality of executable instructions stored in a non-transitory computer readable memory device in communication with a processor dedicated to the first CTM.

In any of the aspects or embodiments described above and herein, the first CTM may include a plurality of executable instructions stored in a non-transitory computer readable memory device in communication with a processor of a system component.

According to another aspect of the present disclosure, a non-transitory computer-readable medium containing instructions for carrying out a method of establishing electronic communications between a plurality of system components within a system is provided. The system has at least one communication bus in communication with the plurality of system components, and the at least one communication bus is configured to transfer electronic communications in a standardized bus format. The instructions when executed cause at least one processor to: a) use a first communication translation module (CTM) to receive at least one electronic communication protocol from a first system component of the plurality of system components, the first CTM including a first protocol storage submodule configured to store a plurality of predetermined system component protocols (PSCPs); b) use the first CTM and a selected PSCP to identify the first system component using at least a portion of the at least one electronic communication protocol of the first system component received by the first CTM; c) use the first CTM and the selected said PSCP from said first protocol storage submodule to translate the at least one electronic communication protocol of the first system component into an outgoing packet in said standardized bus format transferable on the at least one communication bus; and d) transfer the outgoing packet on the at least one communication bus to at least another of the plurality of system components.

In any of the aspects or embodiments described above and herein, the first system component may be replaced with a second system component, and the instructions when executed may cause at least one processor to: a) use the first CTM to receive at least one electronic communication protocol from the second system component of the plurality of system components; b) use the first CTM and a second selected PSCP to identify the second system component using at least a portion of the at least one electronic communication protocol of the second system component received by the first CTM; c) use the first CTM and the second selected said PSCP from the first protocol storage submodule to translate the at least one electronic communication protocol of the second system component into an outgoing packet in the standardized bus format associated with the second system component; and d) transfer the outgoing packet associated with the second system component on the at least one communication bus to at least another of the plurality of system components.

In any of the aspects or embodiments described above and herein, the system may be an open architecture system.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a diagrammatic illustration of a single tier system.

FIG. 2 is a diagrammatic illustration of a multi-tier system.

FIG. 3 is a diagrammatic illustration of a communication stack model that may be used with the present disclosure.

FIG. 4 is a diagrammatic illustration of a present disclosure communication translation module embodiment.

FIG. 5 is a diagrammatic illustration of a present disclosure communication translation module embodiment.

FIG. 6 is a diagrammatic illustration of a present disclosure communication translation module embodiment.

FIG. 7 is a diagrammatic illustration of a single tier system embodiment including a replaced system component and a CTM.

FIG. 8 is a diagrammatic illustration of a single tier system embodiment including an additional system component and a CTM.

FIG. 9 is a flow diagram representing an embodiment of the present disclosure methodology.

FIG. 10 is a flow diagram representing an embodiment of the present disclosure methodology.

FIG. 11 is a diagrammatic illustration of a single tier system embodiment illustrating examples of CTM processor implementation.

### DISCLOSURE OF THE INVENTION

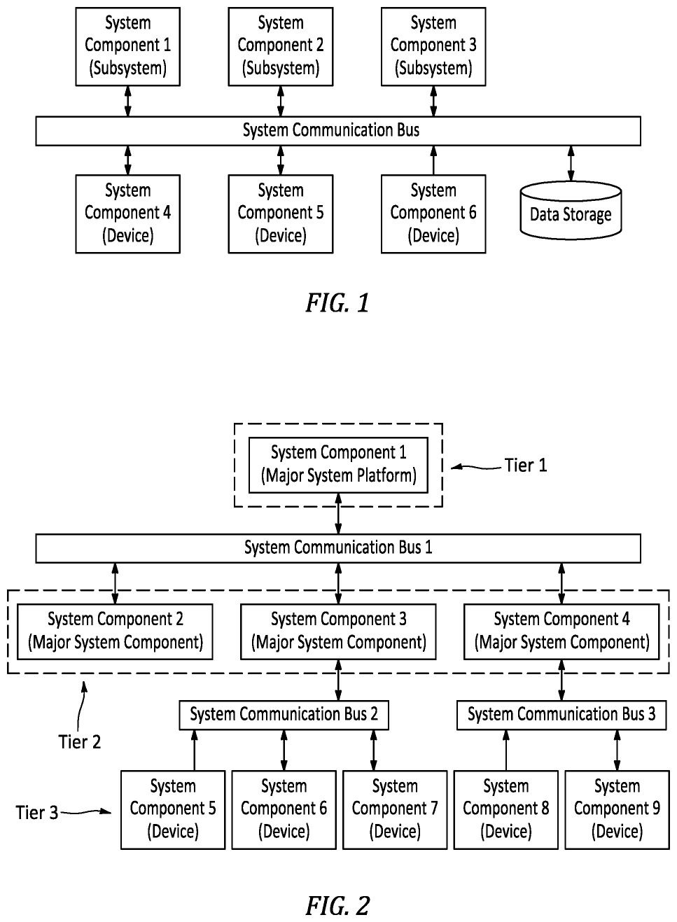

The present disclosure is directed to an electronic communication translation module (“CTM”), a method for using the same that may be used within a system that includes one or more CTMs, and a non-transitory computer-readable medium containing instructions for carrying out the present disclosure method. The present disclosure provides particular utility when implemented with an open architecture system. As will be clear from the description herein, the CTM may also be described as a “composable translation module” because it can be composed to translate a variety of different system component communication protocols. The system may include a plurality of subsystems, or devices, or other component structures (collectively referred to herein as “system components”) that communicate within the system via electronic communications. It is not required that every system component be in electronic communication with every other system component. Typically, however, each system component is in electronic communication with a plurality of the other system components. Some system components may be configured to only transmit electronic communications, other system components may be configured to only receive electronic communications, and still other system components may be configured to both receive and transmit electronic communications. Electronic communications travel between system components via one or more electronic communications pathways, each referred to herein after as a “communication bus”. A system may include one or more communication buses. The present disclosure is not limited to use with any particular type of communication bus, and non-limiting examples of communication buses are provided hereinafter. A system may be configured as a single tier structure or a multi-tier structure. FIG. 1 diagrammatically illustrates a single tier system structure. FIG. 2 diagrammatically illustrates a multi-tier system structure. Within a system, a system component itself may be configured as a single tier structure or a multi-tier structure. The present disclosure is not limited to any particular system configuration or system component configuration.

Present disclosure CTM embodiments may be configured for use in a variety of different system applications, including defense applications (e.g., defense aircraft platforms, weapon management systems, naval platforms, electronic warfare platforms, and the like, or combinations thereof), commercial aircraft applications, medical device applications, Internet of Things (IoT) applications, and the like. Any of these systems may be an open architecture system. The present disclosure is not limited to use with any particular system application. The communication bus or buses that provide electronic communication between system components (or within a system component) are configured to communicate in a standardized manner. The particular communication bus standardization (e.g., message sets, protocols, and the like) chosen for an application may vary depending on the particular application. For example, standardized bus communications in a defense application may vary from standardized bus communications in a medical application, or those in an IoT application, etc. To facilitate the description herein, the present disclosure will be described in terms of standardized bus communications that may be utilized in a defense system application. The present disclosure is not, however, limited to use with any particular modularized system architecture or standardized bus communications.

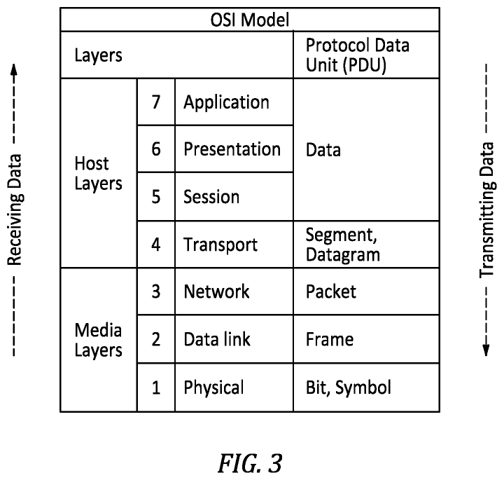

As stated above, a defense system application may use a communication bus configured to transfer communications in a standardized format (referred to hereinafter as a “standardized bus format”) through the communication bus. For example, a communication bus may be configured to pass data packets in a standardized bus format having defined physical layer characteristics and logical layer characteristics. In terms of physical layer characteristics, a standardized bus format may require the data being transferred be formatted according to Ethernet standards, TCP/IP standards, UDP/IP standards, Controller Area Network (CAN) standards, standards that permit serial transfer, or the like. In terms of logical layer characteristics, a standardized bus format may require logical data be in a standardized data format; e.g., data expressed in a predetermined order, physical parameters defined in predetermined units (e.g., Celsius, radians, newtons, etc.). Another example of a logical layer characteristic is the form of the data required by the standardized bus format; e.g., ASCII format, binary format, etc. FIG. 3 illustrates an example of a communication stack model that may be used as a basis for a standardized bus format. The communication stack model shown in FIG. 3 is an open systems interconnection model (“OSI Model”). As can be seen in FIG. 3, the physical layer lies beneath the logical layers and the ability of the model to receive and transmit data is indicated. The present disclosure is not limited to a standardized bus format based on an OSI Model, or any particular standardized bus format for a data bus.

As stated above, a goal of a modular system is an ability to add or remove and replace system components that electronically communicate within the system. Historically, the ability to modify a system (e.g., add or remove and replace a system component) and enable the requisite electronic communications has been accomplished either by designing/modifying a system component to electronically communicate with the system or by providing a custom software interface that enables the system component to communicate directly with other system components. Such custom interfaces typically require a software package that translates the communication protocols of the new system component to the communication protocols of each specific system component interacting with the new system component. Hence, before the new system component can be added to the system, it is necessary under existing practices to either modify the new system component or create a translation software package specifically for each new system component. This existing approach is almost always costly and labor intensive, inhibits system updates and reconfigurations, and very often prevents a plug-and-play approach. Adoption of certain interface standards have lessened the task of establishing electronic communications, but have not achieved the desired plug-and-play modularity. For example, in an established system it may be desirable to remove and replace an existing system component with an updated system component; e.g., replace an existing global positioning system (GPS) sensor with a new GPS sensor updated to communicate with GPS advances. In such a scenario, both the existing and new GPS sensors may be configured with an RS-422 high-speed serial interface and yet produce data in significantly different formats. In other instances, it may be desirable to change data input into a system. For example, a system update may obviate the need for a first type of sensor input and necessitate the input of a second type of sensor. The original sensor and the new sensor may each be configured with the same type of interface (e.g., a USB interface) but the form of the data produced by the new sensor (e.g., ASCII) is completely different from the form of the data produced by the original sensor (e.g., binary). As can be seen from these examples, absent a custom electronic communications interface, it is very unlikely that such system components could be swapped out to update or alter an input into the system.

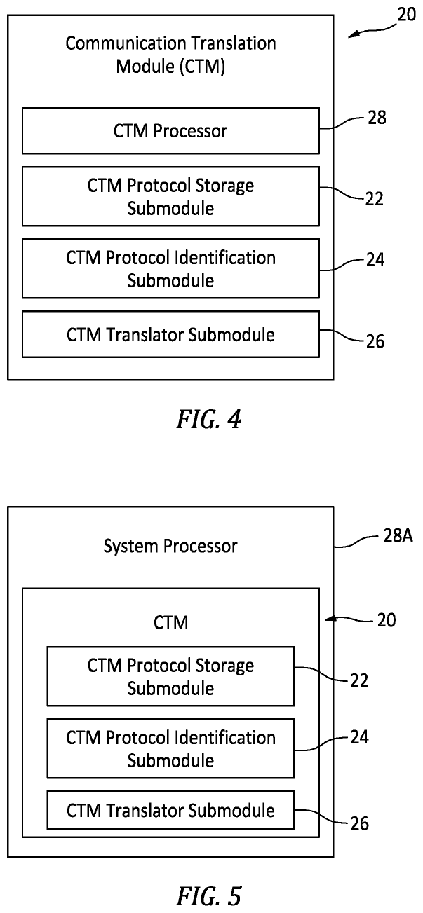

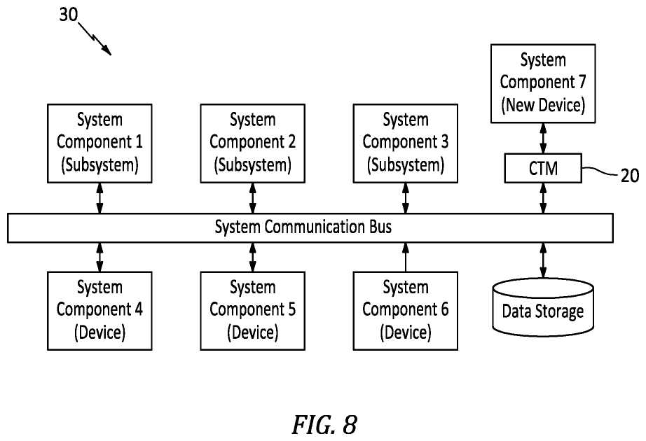

Referring to FIGS. 4-6, the present disclosure provides a novel and unobvious electronic communications translation module (CTM) 20 that may be used in a variety of different type systems, including an open architecture system (system 30, see FIGS. 7 and 8), and a method that significantly facilitates system electronic communications and makes it possible in many instances to arrive at a plug-and-play level of system modularity. Embodiments of the present disclosure include a CTM 20 that is configured with instructions that will translate communication protocols utilized by a new system component to a standardized bus format utilized by a communication bus with which the system component is in communication. The CTM 20 includes or is in communication with a protocol storage submodule 22, a protocol identification submodule 24, and a translator submodule 26. The aforesaid submodules are described herein separately in terms of functionality to facilitate the description. Each of these submodules may include a set of stored instructions (e.g., software) executable by a processor to perform the described functionalities and may include or function with hardware; e.g., a memory device. The CTM 20 may include further stored instructions to facilitate the functionalities described herein; e.g., to coordinate the operation of the submodules. The submodules may be separate or combined with one another and the present disclosure is not limited to any particular configuration unless otherwise described herein. The CTM instructions may be executed by a processor 28 to effectuate electronic communications between the new system component and the system 30. The aforesaid processor 28 may be dedicated to the CTM 20, or alternatively the CTM 20 may be hosted by a processor 28A within the system 30 that provides functionality within the system 30 beyond the CTM 20; e.g., see FIG. 5. The term “processor” as used herein refers to any type of computing device, computational circuit, processor(s), microprocessor(s), CPU, computer, or the like capable of executing a series of instructions that are stored in memory. The instructions may include an operating system, and/or executable software modules such as program files, stored data, buffers, drivers, utilities, and the like. In some embodiments, the instructions may be stored in a form other than software; e.g., firmware or the like. The executable instructions may apply to any functionality described herein to enable the CTM 20 to accomplish the same. The processor 28 includes or is in communication with one or more memory devices. The memory device is not limited to any particular type of memory device, and the memory device may store instructions and/or data in a non-transitory manner. Examples of memory devices that may be used include read-only memory, random access memory, volatile memory, non-volatile memory, static memory, dynamic memory, flash memory, cache memory, and/or any device that stores digital information.

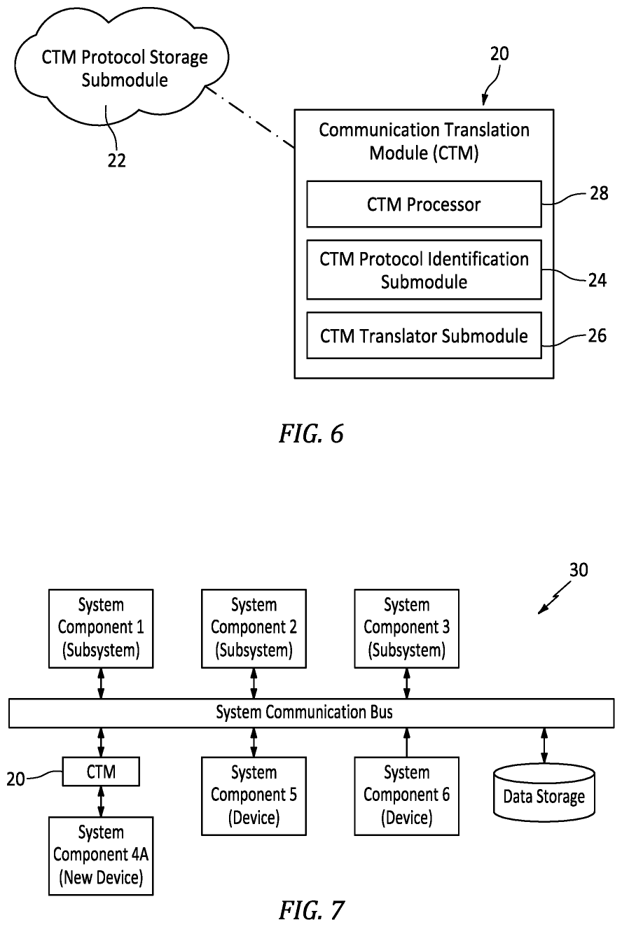

The protocol storage submodule 22 includes or is a memory device (e.g., as described above) that stores a plurality of predetermined system component protocols (“PSCP”). Each PSCP is associated with the communication protocol(s) produced by a system component and is used for translating those communication protocol(s). Each PSCP includes instructions configured to permit translation of physical and logical protocol elements associated with the system component communication protocol(s) to a standardized bus format that is transferrable along the data bus with which the new system component is in communication. In some embodiments, a PSCP may also include instructions that provide a mapping for system component communications. The PSCPs may include an identifier portion that may be used by the protocol identification submodule to identify a protocol received from a new system component (e.g., by comparison between the identifier portion and at least a portion of the new system component protocol). A PSCP stored in the protocol storage submodule may be associated with a system component such as a COTS device, or a known subsystem, or the like. In some embodiments, the protocol storage submodule 22 may store a substantial number of PSCPs to facilitate plug-and-play of a substantial number of system components. The protocol storage submodule 22 may be in direct communication with the CTM processor 28, and the PSCPs may be a portion of CTM instructions. For example, in those instances wherein a CTM 20 includes a dedicated processor 28, the CTM 20 may also include one or more memory devices operable to store CTM instructions. One or more of the CTM's memory devices (or a portion of one of the CTM memory devices) may function as the protocol storage submodule 22. Similarly, if the CTM 20 is hosted by a processor 28A not dedicated to the CTM 20, a memory device in communication with that processor 28A may function as the protocol storage submodule 22. In some embodiments, the protocol storage submodule 22 may be in electronic communication with the CTM 20 but remotely located. For example, the protocol storage submodule 22 may be cloud based; e.g., see FIG. 6.

The protocol identification submodule 24 may be a plurality of executable instructions configured to identify the new system component using at least part of a protocol produced by the new system component. The system 30 may be configured such that a new system component will produce an unsolicited initial communication to the system 30 or may be configured to produce an initial communication to the system 30 upon being prompted to do so. Either way, the initial communication is received by the CTM 20 and is evaluated by the protocol identification submodule 24 using the protocol storage submodule 22. For example, and as described above, PSCPs stored within the protocol storage submodule 22 may each have an identifier portion. The protocol identification submodule 24 may identify a new system component by comparing the protocol (or a portion thereof) produced by the new system component to the stored PSCP identifier portions. Once the appropriate PSCP is identified, that PSCP can be flagged for use by the translator submodule 26 to permit electronic communications between the new system component and the system data bus (or vice versa if the electronic communications are bidirectional). The present disclosure is not limited to any particular process for identifying new system components other than using the PSCPs (e.g., using the identifier portions of the PSCPs) stored in the protocol storage submodule 22; e.g., an identifier portion may be a portion or all of a respective PSCP, and the identification process may use a comparative step, or a logic tree process, or the like.

The translator submodule 26 may be a plurality of executable instructions configured to use a selected PSCP to translate all or a portion of a system component protocol into a standardized bus format for transport along a system data bus (or vice versa). The specific translation performed by the translator submodule 26 may vary depending upon the specifics of the system component protocol and the standardized bus format. The translator submodule 26 may parse and translate one or more physical protocol elements from the system component protocol into physical protocol elements associated with the standardized bus format, or the translator submodule 26 may translate one or more logical protocol elements from the system component protocol into logical protocol elements associated with the standardized bus format, or the translator submodule 26 may translate some combination of physical and logical protocol elements. In some embodiments, the translator submodule 26 may translate multiple protocol layers simultaneously; e.g., translate one or more physical layers simultaneously, or one or more logical layers simultaneously, etc. As stated above, in some instances the translator submodule 26 may provide a mapping for the system component protocol.

To illustrate the utility of the present disclosure, examples of how a present disclosure CTM 20 embodiment may be used in a system 30 (e.g., an open architecture system) are provided below.

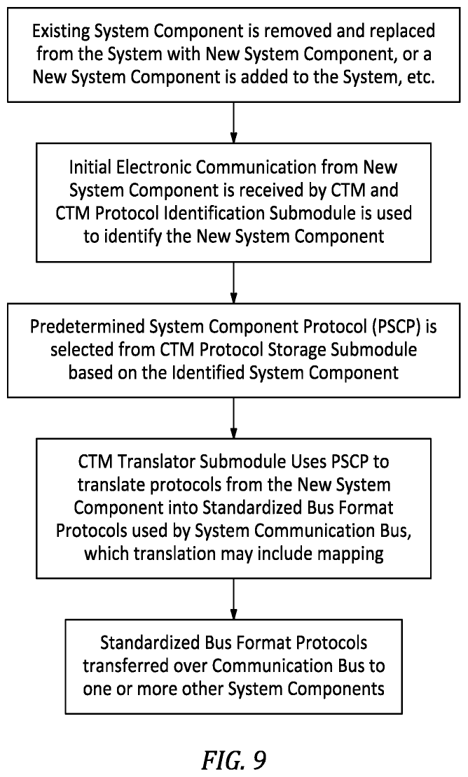

Referring to FIGS. 7 and 9, an exemplary single tier system 30 is diagrammatically shown. The system 30 diagrammatically illustrated in FIG. 6 is the similar to that diagrammatically shown in FIG. 1 except that the system 30 has been modified by removing and replacing System Component 4 with new System Component 4A, one or more present disclosure CTMs 20 have been included, and the System Communication Bus is configured to pass data packets in a standardized bus format.

System Component 4A electronically communicates using protocols that differ from the protocols used by System Component 4. For example, System Component 4A may use protocols having physical layer attributes, or logical layer attributes, or some combination thereof, that differ from those used by System Component 4. Hence, absent the present disclosure CTM 20, new System Component 4A would likely not be able to electronically communicate with other system components within the system 30 without a custom interface that translates the communication protocols of the System Component 4A to the communication protocols of each specific system component to which System Component 4A is intended to communicate, and provides the requisite mapping to those other system components.

The present disclosure CTM 20, in contrast, is configured to enable electronic communications from System Component 4A to System Communication Bus and thereafter to other system components. In those instances where bidirectional communications are utilized, the CTM 20 may also be configured to enable electronic communications from the System Communication Bus to System Component 4A. When introduced to the system 30, System Component 4A may be configured to produce an unsolicited initial communication to the system 30 or may be configured to produce an initial communication to the system 30 upon being prompted to do so. Either way, the initial communication is received by the CTM 20. The CTM protocol identification submodule 24 may identify System Component 4A on the basis of the initial communication and using the protocol storage submodule 22. For example, the protocol identification submodule 24 may access the protocol storage submodule 22 to find a PSCP stored in the protocol storage submodule 22 that corresponds with the initial communication from the System Component 4A. As stated above, the process of identifying a PSCP that corresponds with the initial communication from the System Component 4A may take a variety of different forms; e.g., each of the stored PSCPs may have an identifier portion that can be compared to a portion or all of the communication from the System Component 4A to determine correspondence. The present disclosure is not limited to any particular methodology for identifying the new System Component 4A.

Once the appropriate PSCP is identified, that PSCP can be used by the translator submodule 26 to translate all or a portion of a system component protocol from new System Component 4A into a standardized bus format to permit transport along the system data bus (or vice versa for opposite direction communication). As stated above, the specific translation performed by the translator submodule 26 may vary depending upon the specifics of the new System Component 4A and the standardized bus format of the system data bus. The translator submodule 26 may parse and translate one or more physical protocol elements from the System Component 4A protocol(s) into physical protocol elements associated with the standardized bus format, or the translator submodule 26 may translate one or more logical protocol elements from the System Component 4A protocol(s) into logical protocol elements associated with the standardized bus format, or the translator submodule 26 may translate some combination of physical and logical protocols elements. In addition, and as stated above, some embodiments of the translator submodule 26 may be configured to translate multiple protocol layers simultaneously and may be configured to provide a mapping for the translated System Component 4A protocol(s) within the system 30.

Once the translator submodule 26 translates the System Component 4A protocol(s) into a standardized bus format, the translated protocols may be input into the system data bus for use by other system components within the system 30. A system component receiving the translated protocol originating from the System Component 4A may also include a CTM 20 or other translator configured to translate the protocol from the standardized bus format to a format that can be utilized by the receiving system component. In both instances and as stated above, in instances where communications are bidirectional, the respective CTM 20 may be configured to translate protocols in both directions; e.g., to and from respective system components.

As another example and referring to FIGS. 8 and 9, FIG. 8 diagrammatically illustrates an exemplary single tier system 30. The system 30 diagrammatically shown in FIG. 8 is similar to that diagrammatically in FIG. 1 except that the system 30 has been modified by adding new System Component 7, one or more present disclosure CTMs 20 have been included, and the System Communication Bus is configured to transfer communications in a standardized bus format.

Similar to the example provided above with respect to FIG. 7, System Component 7 electronically communicates using a protocol having physical layer attributes and logical layer attributes, and would likely not be able to electronically communicate to other system components without a custom interface. An initial communication from System Component 7 is introduced to the system 30 and is received by the CTM 20. The CTM protocol identification submodule 24 may identify System Component 7 on the basis of the initial communication and using the protocol storage submodule 22 in the manner described above. Once the appropriate PSCP for System Component 7 is identified, that PSCP can be used by the translator submodule 26 to translate all or a portion of a system component protocol from new System Component 7 into a standardized bus format to permit transport along a system data bus. Once the translator submodule 26 translates the System Component 7 protocol(s) into a standardized bus format, the translated protocols may be input into the system data bus for use by one or more other system components within the system 30. A system component receiving the translated protocol originating from the System Component 7 may also include a CTM 20 or other translator configured to translate the protocol in standardized bus format to a format that can be utilized by the receiving system component. In both instances and as stated above, in instances where communications are bidirectional, the respective CTM 20 may be configured to translate protocols in both directions; e.g., to and from the respective system component.

As is clear from the above description and examples, the present disclosure facilitates system electronic communications and modularization and makes it possible in many instances to have a plug-and-play level of system modularity; e.g., using the present disclosure, the replacement of System Component 4 with System Component 4A and/or the addition of new System Component 7 is a plug-and-play process that does not require any system redesign or recompiling, and does not require the development of a custom interface that translates the communication protocols of System Component 4A or System Component 7 to the communication protocols of each specific system component to which System Component 4A or 7 is intended to communicate.

In some instances, it may be desirable to introduce a new system component into a system that is then not then recognizable by a CTM 20; e.g., the protocol storage submodule 22 of the CTM 20 does not then currently include a PSCP that corresponds to the new system component. In such instances, the protocol storage submodule 22 may be updated to include the appropriate PSCP prior to the introduction of the new system component into the system 30. In some instances, CTMs 20 may be configured for periodic updating of the protocol storage submodule 22; e.g., to add new PSCPs, and/or to remove outdated PSCPs, etc. In this manner, a present disclosure CTM 20 is able to facilitate the ability of a system 30 to operate with a plug-and-play modularity over a greater period of time without the need for system redesign or recompilation. In some embodiments, a CTM 20 may be configured to automatically update its protocol storage submodule 22 with a new PSCP that corresponds with a new system component that was not previously recognizable by the CTM 20. In these instances, the CTM 20 may include instructions that parse the communications from the new system component, and prepare an appropriate PSCP based on the parsed data from the new system component communications.

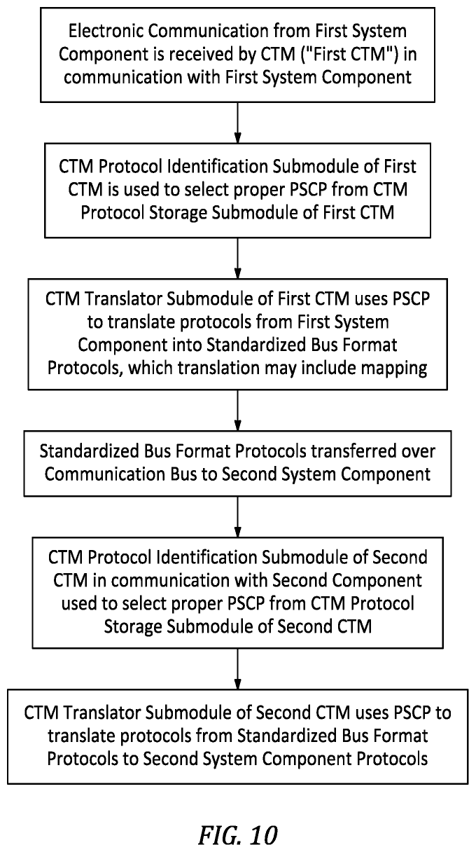

The description above and flow charts of FIGS. 7-9 illustrate how present disclosure CTMs 20 may be used to facilitate electronic communications within a system when a new system component is introduced into the system. The flow chart of FIG. 10 diagrammatically illustrates an example of how an electronic communication may be accomplished between two system components using present disclosure CTMs 20; e.g., an initial electronic communication or a return electronic communication for bidirectional communications.

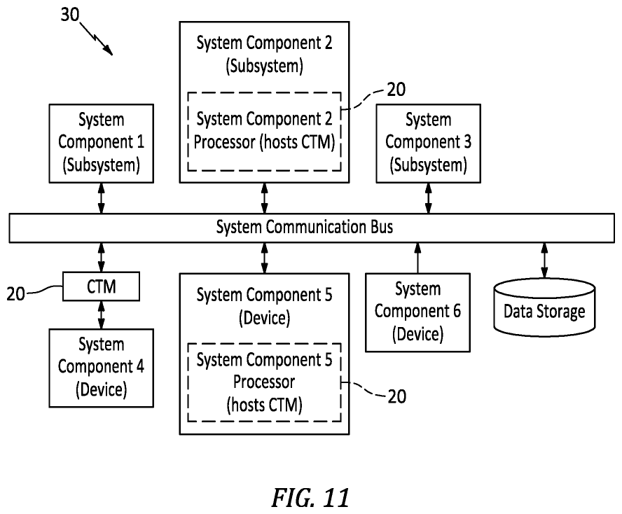

FIG. 11 diagrammatically illustrates another exemplary single tier system 30. This exemplary system 30 embodiment is provided to make clear that a CTM 20 may be hosted on a processor that is dedicated to the CTM, or alternatively a CTM 20 may be hosted on the processor of a system component (e.g., an existing system component, sometimes referred to as a “legacy system component”). Within FIG. 11, a first CTM having a dedicated processor is shown in communication with System Component 4, a second CTM is hosted on a processor of System Component 2, and a third CTM is hosted on a processor of System Component 5. As indicated above, the present disclosure is not limited to CTMs 20 on dedicated processors, or CTMS 20 on hosted processors, and may include some combination thereof. The ability of a present disclosure CTMs 20 to be hosted on a system processor can provide greater utility, cost savings, and facilitate implementation.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

1. An electronic communication translation module (CTM) for use with a system having at least one communication bus, the communication bus configured to transfer electronic communications in a standardized bus format, the system having a plurality of system components in electronic communication with the communication bus, and each system component configured to produce at least one electronic communication protocol, the CTM comprising:
a protocol storage submodule configured to store a plurality of predetermined system component protocols (PSCPs), each PSCP associated with the at least one said electronic communication protocol of a respective said system component; and
a processor in communication with the protocol storage submodule storing instructions, which instructions when executed cause the processor to:
identify a respective said system component using at least a portion of the respective said at least one electronic communication protocol of the respective said system component and a selected said PSCP; and
translate at least a portion of the respective at least one said system component electronic communication protocol into a said standardized bus format transferable on the at least one communication bus using said selected PSCP.

2. The electronic CTM of claim 1, wherein the instructions when executed cause the processor to translate one or more physical protocol elements associated with at least one said system component electronic communication protocol into said standardized bus format using said selected PSCP.

3. The electronic CTM of claim 2, wherein the instructions when executed cause the processor to translate one or more logical protocol elements associated with at least one said system component electronic communication protocol into said standardized bus format using said selected PSCP.

4. The electronic CTM of claim 1, wherein the instructions when executed cause the processor to translate one or more logical protocol elements associated with at least one said system component electronic communication protocol into said standardized bus format using said selected PSCP.

5. The electronic CTM of claim 1, wherein the electronic communication translation module is configured for bidirectional electronic communication translation.

6. The electronic CTM of claim 1, wherein the electronic communication translation module is configured to receive electronic communications in said standardized bus format and the instructions when executed cause the processor to translate the received electronic communications in said standardized bus format using at least one said PSCP.

7. The electronic CTM of claim 1, wherein the electronic communication translation module is configured to identify a plurality of system components, each said system component different from each of the other said system components.

8. A method of establishing electronic communications between a plurality of system components within a system, the system having at least one communication bus in communication with the plurality of system components, and the at least one communication bus configured to transfer electronic communications in a standardized bus format, the method comprising:
using a first communication translation module (CTM) to receive at least one electronic communication protocol from a first system component of the plurality of system components, the first CTM including a first protocol storage submodule configured to store a plurality of predetermined system component protocols (PSCPs);
using the first CTM and a selected said PSCP to identify the first system component using at least a portion of the at least one electronic communication protocol of the first system component received by the first CTM;
using the first CTM and the selected said PSCP from said first protocol storage submodule to translate the at least one electronic communication protocol of the first system component into an outgoing packet in said standardized bus format transferable on the at least one communication bus; and
transferring the outgoing packet on the at least one communication bus to at least another of the plurality of system components.

9. The method of claim 8, wherein the at least another of the plurality of system components is a second system component, the method further comprising:
using a second CTM in communication with the second system component to receive the outgoing packet, the second CTM including a second protocol storage submodule configured to store a plurality of PSCPs;
using the second CTM and a said PSCP from said second protocol storage submodule to translate the outgoing packet from the standardized bus format to at least a portion of an electronic communication protocol of the second system component.

10. The method of claim 9, wherein the first CTM and the second CTM are each configured for bidirectional electronic communications.

11. The method of claim 8, wherein the translation of the at least one electronic communication protocol of the first system component includes translating one or more physical protocol elements associated with at least one said system component electronic communication protocol into said standardized bus format using said selected PSCP from said first protocol storage submodule.

12. The method of claim 11, wherein the translation of the at least one electronic communication protocol of the first system component includes translating one or more logical protocol elements associated with at least one said system component electronic communication protocol into said standardized bus format using said selected PSCP from said first protocol storage submodule.

13. The method of claim 8, wherein the translation of the at least one electronic communication protocol of the first system component includes translating one or more logical protocol elements associated with at least one said system component electronic communication protocol into said standardized bus format using said selected PSCP from said first protocol storage submodule.

14. The method of claim 8, wherein the first system component is new to the system.

15. The method of claim 8 further comprising:
replacing the first system component with a second system component;
using the first CTM to receive at least one electronic communication protocol from the second system component of the plurality of system components;
using the first CTM and a second selected said PSCP to identify the second system component using at least a portion of the at least one electronic communication protocol of the second system component received by the first CTM;
using the first CTM and the second selected said PSCP from said first protocol storage submodule to translate the at least one electronic communication protocol of the second system component into a said outgoing packet in said standardized bus format associated with the second system component; and
transferring the outgoing packet associated with the second system component on the at least one communication bus to at least another of the plurality of system components.

16. The method of claim 8, wherein the first CTM comprises a plurality of executable instructions stored in a non-transitory computer readable memory device in communication with a processor dedicated to the first CTM.

17. The method of claim 8, wherein the first CTM comprises a plurality of executable instructions stored in a non-transitory computer readable memory device in communication with a processor of a said system component.

18. A non-transitory computer-readable medium containing instructions for carrying out a method of establishing electronic communications between a plurality of system components within a system, the system having at least one communication bus in communication with the plurality of system components, and the at least one communication bus configured to transfer electronic communications in a standardized bus format, the instructions when executed cause at least one processor to:
use a first communication translation module (CTM) to receive at least one electronic communication protocol from a first system component of the plurality of system components, the first CTM including a first protocol storage submodule configured to store a plurality of predetermined system component protocols (PSCPs);
use the first CTM and a selected said PSCP to identify the first system component using at least a portion of the at least one electronic communication protocol of the first system component received by the first CTM;
use the first CTM and the selected said PSCP from said first protocol storage submodule to translate the at least one electronic communication protocol of the first system component into an outgoing packet in said standardized bus format transferable on the at least one communication bus; and
transfer the outgoing packet on the at least one communication bus to at least another of the plurality of system components.

19. The non-transitory computer-readable medium of claim 18, wherein the at least another of the plurality of system components is a second system component, and the instructions when executed cause at least one processor to:
use a second CTM in communication with the second system component to receive the outgoing packet, the second CTM including a second protocol storage submodule configured to store a plurality of PSCPs;
use the second CTM and a said PSCP from said second protocol storage submodule to translate the outgoing packet from the standardized bus format to at least a portion of an electronic communication protocol of the second system component.

20. The non-transitory computer-readable medium of claim 18, wherein the first system component is replaced with a second system component, and the instructions when executed cause at least one processor to:
use the first CTM to receive at least one electronic communication protocol from the second system component of the plurality of system components;
use the first CTM and a second selected said PSCP to identify the second system component using at least a portion of the at least one electronic communication protocol of the second system component received by the first CTM;
use the first CTM and the second selected said PSCP from said first protocol storage submodule to translate the at least one electronic communication protocol of the second system component into a said outgoing packet in said standardized bus format associated with the second system component; and
transfer the outgoing packet associated with the second system component on the at least one communication bus to at least another of the plurality of system components.
